(19) United States
(12) Patent Application Publication
(10) Pub. No.: US 2013/0079691 A1
(43) Pub. Date: Mar. 28, 2013

(54) SCRATCHING DEVICE

(71) Applicant: Linda Faye Huxable, Margate, FL (US)

(72) Inventor: Linda Faye Huxable, Margate, FL (US)

(21) Appl. No.: 13/620,672

(22) Filed: Sep. 14, 2012

Related U.S. Application Data
(60) Provisional application No. 61/535,700, filed on Sep. 16, 2011.

(51) Int. Cl. A61H 7/00

(52) U.S. Cl. CPC A61H 7/003
USPC 601/136

(57) ABSTRACT

A device made to easily scratch the users scalp. It is easy to use and clean. It has a handle with a prong extending therefrom. It may have a snap-on cap to receive the prong and a shoulder.

### RELATED APPLICATIONS

[000.5] This patent application claims priority from provisional patent application No. 61/535,700 having a filing date of Sep. 16, 2011.

### FIELD OF THE INVENTION

This invention relates to an apparatus that can be used to scratch where needed, such as the scalp of the user.

### BACKGROUND OF THE INVENTION

Typically, people use their fingers to scratch their scalp. However drawbacks may include not being able to scratch one's scalp due to, for example, overly-long fingernails, short fingernails, or bitten fingernails.

Another disadvantage may be that the user may have a substance in their hair, which they do not want on their fingers, such as hair mousse, styling gel, or other products.

There exists a need for a device that is easy to carry, and safe to use to scratch one's scalp.

There exists a need for a device that allows one to scratch their scalp without using one's fingers.

Multiple embodiments of the system are disclosed herein. It will be understood that other objects and purposes of the invention, and variations thereof, will be apparent upon reading the following specification and inspecting the accompanying drawings.

### REFERENCE NUMERALS LIST

10 scratching device
20 scratching portion
30 cap
40 handle
50 prong
60 chamber
70 shoulder
80 cap diameter
90 cap length
100 handle length
110 prong length
120 straight prong portion
130 angled prong portion
140 tip
150 flat side
160 concave side
170 length of shoulder
180 angle length
190 closed position
200 prong thickness
210 prong width

### SUMMARY OF THE INVENTION

One aspect of the present invention is a scratching device, comprising: a handle; a prong extending away from said handle along a longitudinal axis said prong having a flat side and a concave side; and said prong having two angled portions to terminate at a blunt tip.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention in a closed position with a sectional view of the cap;

FIG. 2 is a second pictorial view of the present invention;

FIG. 3 is third pictorial view of the present invention;

FIG. 4 is a fourth pictorial view of the present invention; and

FIG. 5 is a fifth pictorial view of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

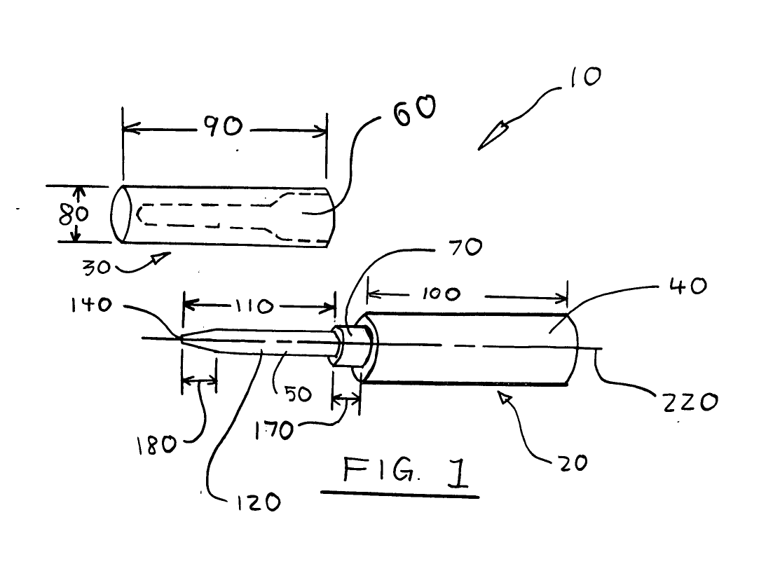

FIG. 1 illustrates one embodiment of the scratching device 10 having a scratching portion 20 and a cap 30. The scratching portion 20 may have a handle 40, with a shoulder 70 extending longitudinally away from the handle 40, and a prong 50 may extend longitudinally away from the shoulder 70. The prong 50 may have a straight prong portion 120, and an angled portion 130. The prong 50 may terminate at a tip 140.

In one embodiment the straight prong portion 120 may have a length 110 of about 15/16 of an inch. In one embodiment the shoulder 70 may have a shoulder length 170 of about ⅛ of an inch. In one embodiment the prong 50 may have a length of about 1⅛ of an inch. In one embodiment the angled prong portion 130 may have an angle length of about ¼ of an inch.

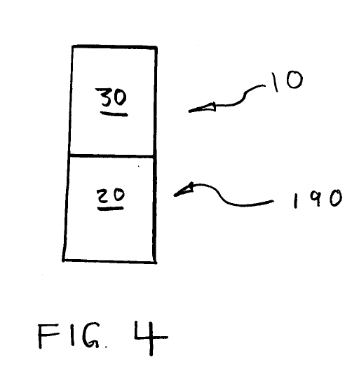

In one embodiment the cap length 90 may be about 1½ inches, and the cap 30 may be about ½ inches in diameter. The cap 30 may have a chamber 60 so as to receive the shoulder 70 and prong 50 therein, and be releasibly sealed to the scratching portion 20 so both can be maintained in a closed position 190, as seen in FIG. 4. The prong 50 may terminate at a tip 140. In one embodiment the tip may have a length of about 1/16 of an inch. In one embodiment the prong 50 may have a thickness of about 1/16 of an inch. The prong 50 may have a prong width 210 of about 7/32 of an inch. The handle 40 may have a length of about 1 5/16 inches. The handle 40 may have a diameter of about ⅝ of an inch.

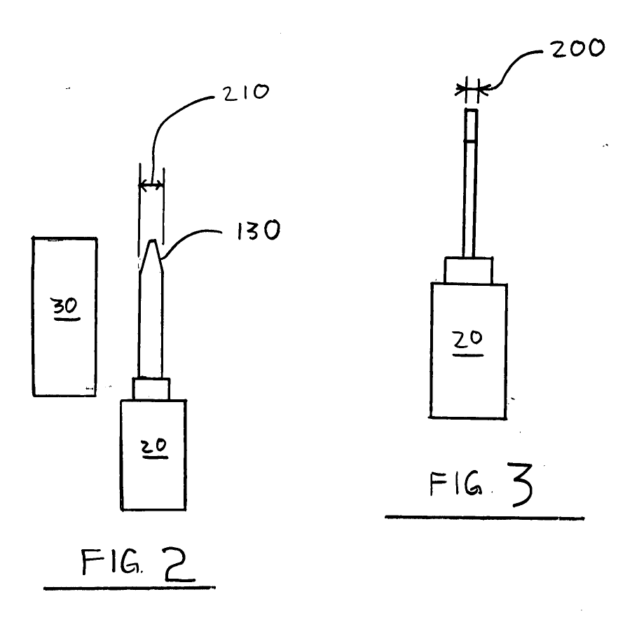

FIG. 2 illustrates one embodiment showing the prong width 210.

FIG. 3 illustrates one embodiment showing the prong thickness 200.

FIG. 4 illustrates an embodiment of the present invention in a closed position 190.

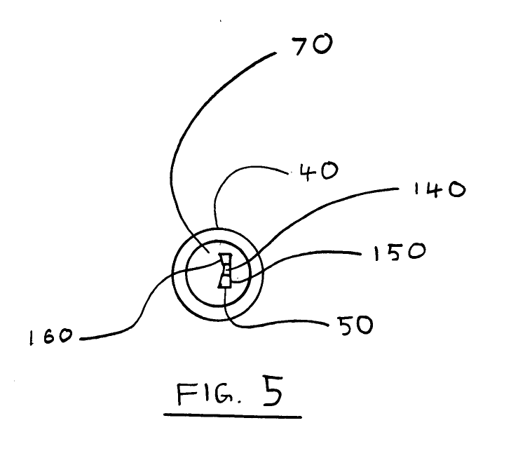

FIG. 5 illustrates an embodiment were the prong 50 may have a flat side 150 and a concave side 160. Depending on the user, some may prefer to scratch primarily with the concave side 160, or the straight side 150. The tip 140 may be blunt and may have the two angle prong portions 130 illustrated in FIGS. 1, 2, 3, and 5.

In one embodiment, the present invention 10 may be made from Delrin® Plastic. The cap 30 may snap on and off of the handle 40.

It should be understood, of course, that the foregoing relates to exemplary embodiments of the invention and that modifications may be made without departing from the spirit and scope of the invention as set forth in the following claims.

I claim:

1. Scratching device (10), comprising:
a handle (40); a prong (50) extending away from said handle (40) along a longitudinal axis (220);
said prong (50) having a flat side (150) and a concave side (160); and
said prong (50) having two angled portions (130) to terminate at a blunt tip (140).

2. The apparatus of claim 1 (10), further comprising:
a shoulder (70) disposed between said prong (50) and said handle (40).

3. The apparatus of claim 1 (10), further comprising:
a cap (30) having a chamber (60) that is capable of receiving said prong (50) therein, and to be releasibly connected to said handle (40).

4. The apparatus of claim 1 (10), further comprising:
a cap (30) having a chamber (60) that is capable of receiving said prong (50) and said shoulder (70) therein, and to be releasibly connected to said handle (40).

5. The apparatus of claim 1 (10), wherein said prong (50) has a length of about 1 3/16 inches from the shoulder (70) to the tip (140), and the straight prong portion (120) has a length of about 15/16 of an inch from the shoulder (70) the angled prong portion (130).

6. The apparatus of claim 1 (10), wherein said handle (40) has a length of about 1 5/16 inches.

7. The apparatus of claim 2 (10), wherein said shoulder (70) is about ⅛ inch long.

8. The apparatus of claim 1 (10), wherein said handle (40) has is cylindrical in shape and has a diameter of about ⅝ of an inch.

9. The apparatus of claim 1 (10), wherein said apparatus (10) is made from Delrin® Plastic.
